(19) United States
(12) Patent Application Publication
(10) Pub. No.: US 2017/0132638 A1
(43) Pub. Date: May 11, 2017

(54) RELEVANT INFORMATION ACQUISITION METHOD AND APPARATUS, AND STORAGE MEDIUM

(71) Applicant: HITACHI, LTD., Tokyo (JP)

(72) Inventors: Kentarou CHIGUSA, Tokyo (JP); Masashi TSUCHIDA, Tokyo (JP); Yukio NAKANO, Tokyo (JP); Sota SATO, Tokyo (JP)

(73) Assignee: HITACHI, LTD., Tokyo (JP)

(21) Appl. No.: 15/318,580

(22) PCT Filed: Dec. 26, 2014
(86) PCT No.: PCT/JP2014/084524

§ 371 Date: Dec. 13, 2016

(51) Int. Cl. G06Q 30/00; G06F 17/30

(52) U.S. Cl. CPC G06Q 30/01; G06F 17/30011; G06F 17/30713

(57) ABSTRACT

A relevant information acquisition method and apparatus include characteristic terms whereby each of the cases is extracted, and relevance among cases is detected based on the extracted characteristic terms of each of the cases and the conversation history documents of other cases. The respective cases are classified into a plurality of clusters, which are an aggregate of high relevance cases, labels assigned to the clusters and representative cases are determined, characteristic terms of the inquiry text are extracted, the cases that may become a reference are acquired based on the extracted characteristic terms and the conversation history document of each of the cases, one or more clusters to which each of the acquired cases belongs are identified, and the labels of each of the identified clusters and at least a part of the conversation history document of the representative cases are categorized and displayed.

### TECHNICAL FIELD

The present invention relates to a relevant information acquisition method and apparatus, as well as to a storage medium, and, for instance, can be suitably applied to a relevant information acquisition apparatus which searches for and acquires cases that are related to the latest inquiry (that may become a reference upon replying to the inquiry) among past cases that have been accumulated in order to reply to an inquiry from a customer in a call center or the like.

### BACKGROUND ART

A call center is required to promptly investigate the cause and offer a solution to an inquiry from a customer, and reply to that customer in a short period of time. Thus, conventionally, adopted was a scheme of accumulating past inquiries and replies and, upon receiving a new inquiry, searching for cases among the accumulated past cases in which the inquiry content is similar to the latest inquiry, and preparing a reply to the latest inquiry based on the search result.

In the foregoing case, PTL 1 discloses a search method of analyzing terms contained in the document (query document) of the search source, and searching for documents containing similar terms, and this method can be used as the search method upon searching for cases in which the inquiry content is similar to the latest inquiry from the customer.

### CITATION LIST

### Patent Literature

PTL 1: Japanese Patent Application Publication No. H11-143902

### SUMMARY OF THE INVENTION

### Problems to be Solved by the Invention

Meanwhile, when there are numerous cases in which the inquiry content is similar to the latest inquiry from the customer, because these numerous cases are collectively displayed as the search result without the result display screen being organized, it is difficult to determine which cases should be referred to upon preparing a reply to the latest inquiry from the customer.

Moreover, according to the search method disclosed in PTL 1, since cases in which similar terms appear in the documents containing the inquiry content from the customer are listed (ranked) at the top, there is a problem in that it is difficult to find the cases that may become a reference in replying to the latest inquiry among the numerous cases that are displayed as the search result.

The present invention was devised in view of the foregoing points, and an object of this invention is to propose a relevant information acquisition method and apparatus, as well as a storage medium, capable of improving the work efficiency of a user as a result of enabling that user to search for optimal cases in response to an inquiry from a customer in a short period of time. Here, the term “optimal case” refers to a case that may become a reference upon examining the cause of and measures taken against an event in replying to an inquiry from a customer.

### Means to Solve the Problems

In order to achieve the foregoing object, the present invention provides a relevant information acquisition method to be executed in a relevant information acquisition apparatus for acquiring, among past cases accumulated with conversation history documents respectively including an inquiry from a customer and a reply to that inquiry, the cases that may become a reference upon examining a cause of and measures taken against an event described in an inquiry text according to contents of a new inquiry from a customer, comprising: a first step of extracting characteristic terms, which characterize each of the cases, from a corresponding conversation history document, and detecting a relevance among the cases based on the extracted characteristic terms of each of the cases and the conversation history documents of other cases; a second step of classifying each of the cases into a plurality of clusters, which are an aggregate of the cases of high relevance, based on the detected relevance among the cases, assigning terms, as labels, which characterize the cluster to that cluster for each of the clusters, and determining representative cases consisting of cases that represents the cluster; a third step of extracting, from the inquiry text, characteristic terms that characterize that inquiry text, and acquiring the cases that may become a reference upon examining the cause of and measures taken against the event described in the inquiry text based on the extracted characteristic terms of the inquiry text and the conversation history document of each of the cases; a fourth step of identifying the one or more clusters to which each of the acquired cases belongs; and a fifth step of classifying and displaying, for each of the clusters, the labels of each of the identified clusters and a part or all of the conversation history document of the representative cases.

The present invention further provides a relevant information acquisition apparatus for acquiring, among past cases accumulated with conversation history documents respectively including an inquiry from a customer and a reply to that inquiry, the cases that may become a reference upon examining a cause of and measures taken against an event described in an inquiry text according to contents of a new inquiry from a customer, comprising: a characteristic term extraction unit for extracting characteristic terms, which characterize the cases or the inquiry text, from a corresponding conversation history document or the inquiry text; an inter-case relevance detection unit for detecting a relevance among the cases based on the characteristic terms of each of the cases extracted by the characteristic term extraction unit and the conversation history documents of other cases; a cluster creation unit for classifying each of the cases into a plurality of clusters, which are an aggregate of the cases of high relevance, based on the relevance among the cases detected by the inter-case relevance detection unit, assigning terms, as labels, which characterize the cluster to that cluster for each of the clusters, and determining representative cases consisting of cases that represents the cluster; a case acquisition unit for acquiring the cases that may become a reference upon examining the cause of and measures taken against the event described in the inquiry text based on the characteristic terms of the inquiry text extracted by the characteristic term extraction unit and the conversation history document of each of the cases; a cluster identification unit for identifying the one or more clusters to which each of the cases, which was acquired by the case acquisition unit, belongs; and a result display unit for classifying and displaying, for each of the clusters, the labels of each of the identified clusters and a part or all of the conversation history document of the representative cases.

The present invention additionally provides a storage medium storing a program for causing a relevant information acquisition apparatus for acquiring, among past cases accumulated with conversation history documents respectively including an inquiry from a customer and a reply to that inquiry, the cases that may become a reference upon examining a cause of and measures taken against an event described in an inquiry text according to contents of a new inquiry from a customer, to execute processing comprising: a first step of extracting characteristic terms, which characterize each of the cases, from a corresponding conversation history document, and detecting a relevance among the cases based on the extracted characteristic terms of each of the cases and the conversation history documents of other cases; a second step of classifying each of the cases into a plurality of clusters, which are an aggregate of the cases of high relevance, based on the detected relevance among the cases, assigning terms, as labels, which characterize the cluster to that cluster for each of the clusters, and determining representative cases consisting of cases that represents the cluster; a third step of extracting, from the inquiry text, characteristic terms that characterize that inquiry text, and acquiring the cases that may become a reference upon examining the cause of and measures taken against the event described in the inquiry text based on the extracted characteristic terms of the inquiry text and the conversation history document of each of the cases; a fourth step of identifying the one or more clusters to which each of the acquired cases belongs; and a fifth step of classifying and displaying, for each of the clusters, the labels of each of the identified clusters and a part or all of the conversation history document of the representative cases.

According to the relevant information acquisition method and apparatus, as well as the storage medium, of the present invention, the cases that may become a reference upon examining a cause of and measures taken against an event described in an inquiry text are classified into a plurality of clusters, which are an aggregate of the cases of high relevance, and, for each of the clusters, the labels of each of the identified clusters and a part or all of the conversation history document of the representative cases are displayed. Thus, a user can search for optimal cases in response to an inquiry from a customer in a short period of time.

### Advantageous Effects of the Invention

According to the present invention, it is possible to realize a relevant information acquisition method and apparatus, as well as a storage medium, capable of improving the work efficiency of a user.

### BRIEF DESCRIPTION OF DRAWINGS

FIG. 1 is a block diagram showing the configuration of the relevant information acquisition apparatus according to the first and third embodiments.

FIG. 2 is a conceptual diagram showing a configuration example of the inter-case relevant information.

FIG. 3 is a conceptual diagram showing a configuration example of the cluster information.

FIG. 4 is a conceptual diagram showing a configuration example of the search history information.

FIG. 5 is an outlined line diagram schematically showing a configuration example of the inquiry text input screen.

FIG. 6 is an outlined line diagram schematically showing a configuration example of the result output screen.

FIG. 7 is a flowchart showing the processing routine of the inter-case relevance detection processing.

FIG. 8 is a flowchart showing the processing routine of the characteristic term extraction processing.

FIG. 9 is a schematic diagram showing the overview of the characteristic term extraction processing.

FIG. 10 is a flowchart showing the processing routine of the cluster creation processing.

FIG. 11 is a conceptual diagram showing a configuration example of a graph.

FIG. 12 is a conceptual diagram explaining clusters.

FIG. 13 is a flowchart showing the processing routine of the optimal case acquisition processing.

FIG. 14 is a block diagram showing the configuration of the relevant information acquisition apparatus according to the second embodiment.

FIG. 15 is an outlined line diagram schematically showing a configuration example of the result output screen according to the second embodiment.

FIG. 16 is a flowchart showing the processing routine of the search history reflection processing.

FIG. 17 is a schematic diagram showing the overview of the characteristic term extraction processing according to the third embodiment.

FIG. 18 is a block diagram showing the configuration of the relevant information acquisition apparatus according to the fourth embodiment.

FIG. 19 is a schematic diagram showing the overview of the characteristic term extraction processing according to the fourth embodiment.

FIG. 20 is a flowchart showing the processing routine of the characteristic term extraction processing according to the fourth embodiment.

### DESCRIPTION OF EMBODIMENTS

An embodiment of the present invention is now explained in detail with reference to the appended drawings.

### (1) First Embodiment

(1-1) Configuration of Relevant Information Acquisition Apparatus According to this Embodiment

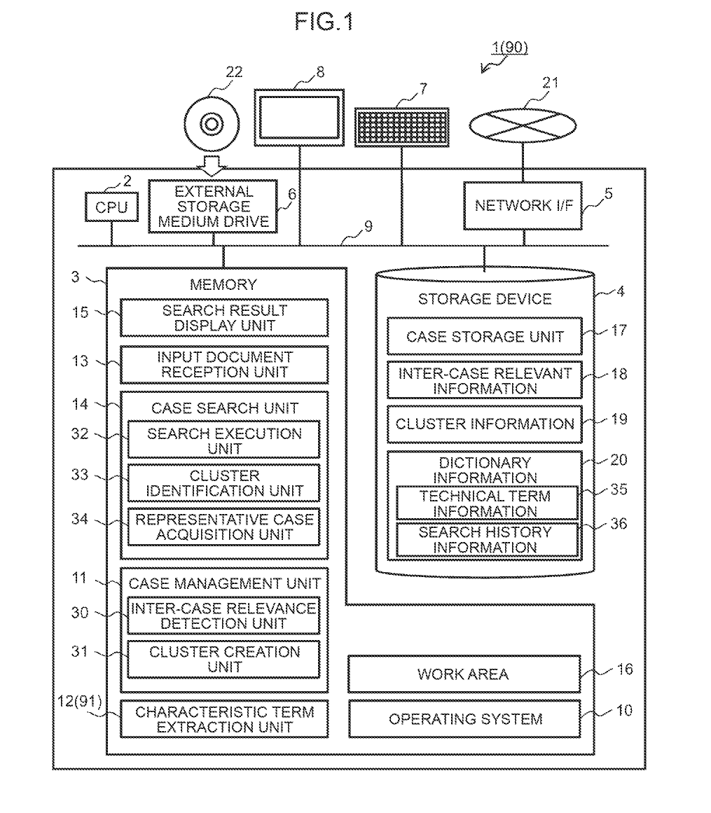

In FIG. 1, reference numeral 1 represents the overall relevant information acquisition apparatus according to this embodiment. The relevant information acquisition apparatus 1 comprises a CPU (Central Processing Unit) 2, a memory 3, a storage device 4, a network interface 5, an external storage medium drive 6, an input device 7 and a display device 8, and is configured by the foregoing components being mutually connected via an internal bus 9.

The CPU 2 is a processor that governs the operational control of the overall relevant information acquisition apparatus 1. Moreover, the memory 3 is configured, for example, from a volatile semiconductor memory, and is used for storing various programs including an operating system (OS) 10. The case management unit 11, the characteristic term extraction unit 12, the input document reception unit 13, the case search unit 14 and the search result display unit 15 described later are also stored and retained in the memory 3. Moreover, the memory 3 is also used as the work memory of the CPU 2. Thus, the memory 3 is provided with a work area 16 to be used by the CPU 2 upon executing various types of processing.

The storage device 4 is configured, for example, from a non-volatile, large-capacity storage device such as a hard disk device or an SSD (Solid State Drive), and is used for retaining programs and data for a long period. In the case of this embodiment, the storage device 4 stores a case storage unit 17 for storing the conversation history document of past cases, inter-case relevant information 18 representing the relevance among cases in which the conversation history document is stored in the case storage unit 17, as well as cluster information 19 and dictionary information 20 described later.

Note that, the term “conversation history document” as used in this embodiment refers to the document (text) representing the contents of the case that was handled by the operator of a call center or the person in charge of resolving problems. The conversation history document at least includes the contents of an inquiry from a customer, and the reply to that inquiry. Moreover, the conversation history document may also include a request to collect application log or system log representing the message communicated to the customer from the user, such as the operator of a call center or the person in charge of resolving problems, application log or system log representing the message communicated from the customer to the person in charge, a request for investigation representing the message communicated from the person in charge to the business division in charge of the product, and/or the reply of the results of the investigation representing the message communicated from the business division in charge of the product to the person in charge.

The network interface 5 is configured, for example, from an NIC (Network Interface Card), and performs protocol control upon communicating with other communication equipment via the network 21. Moreover, the external storage medium drive 6 is a drive of a portable external storage medium 22 such as a CD (Compact Disc), DVD (Digital Versatile Disc) or other disk mediums, or an SD card or other semiconductor memory cards, and reads data from or writes data into the loaded external storage medium 22 under the control of the CPU 2.

The input device 7 is configured, for example, from a keyboard or a mouse, and is used by the user for inputting various types of information or commands. Moreover, the display device 8 is configured, for example, from a liquid crystal display device, and is used for displaying various types of information and various types of GUI (Graphical User Interface).

### (1-2) Various Functions Equipped in Relevant Information Acquisition Apparatus

The various functions equipped in the relevant information acquisition apparatus 1 are now explained. The relevant information acquisition apparatus 1 is equipped with a case clustering function of periodically (for instance, once a week or once a month), or randomly according to the instructions from the user input via the input device 7, detecting a relevance among past cases, classifying the past cases into a plurality of clusters based on the detected relevance among the cases, and assigning, to each of these clusters, terms which characterize that cluster (terms which represent the characteristics of the respective cases belonging to that cluster) as labels.

In effect, with the relevant information acquisition apparatus 1, the conversation history documents of all past cases are accumulated in the case storage unit 17 of the storage device 4. Subsequently, the relevant information acquisition apparatus 1 periodically or randomly extracts, as the characteristic terms, the respective terms that represent the characteristics of the case from the conversation history document of that case with regard to the respective cases in which the conversation history documents are accumulated in the case storage unit 17, and calculates the degree of similarity of each case as a numerical value by comparing the extracted characteristic terms with the respective conversation history documents of other cases. In the ensuing explanation, the foregoing numerical value is referred to as the “similarity”.

Furthermore, the relevant information acquisition apparatus 1 detects, as cases which are mutually relevant, the cases in which the similarity of the cases calculated as described above is equal to or greater than a predetermined threshold (this is hereinafter referred to as the “similarity threshold”). Subsequently, the relevant information acquisition apparatus 1 classifies the respective cases into a plurality of clusters based on the detected relevance among the cases. Moreover, the relevant information acquisition apparatus 1 thereafter assigns terms, as labels, which characterize the cluster to that cluster for each of the clusters, and additionally extracts cases that represent that cluster for each of the clusters (these are hereinafter referred to as the “representative cases”).

Meanwhile, the relevant information acquisition apparatus 1 is also equipped with an optimal case acquisition function of searching and acquiring, upon receiving a search instruction to search for cases that are similar to the new inquiry from a customer, a cluster to which belong cases that may become a reference upon examining a cause of and measures taken against an event described in an inquiry text according to subject matter of that inquiry (referring to cases that are optimal reference to the inquiry text, and this is hereinafter referred to as the “optimal cases” in relation to the inquiry or inquiry text), and presenting, to the user, the labels of the acquired cluster and the cases that represents that cluster.

In effect, when the relevant information acquisition apparatus 1 receives a document representing the inquiry content from a customer (this is hereinafter referred to as the “inquiry text”) and a search instruction to search for cases of an inquiry content that is similar to that inquiry text through the operation of the input device 7 by the user, the relevant information acquisition apparatus 1 extracts the terms that characterize the inquiry text as the characteristic terms of that inquiry text.

Subsequently, the relevant information acquisition apparatus 1 uses the extracted characteristic terms of the inquiry text and searches for cases in which the inquiry content is similar to the inquiry text among the past cases. Moreover, the relevant information acquisition apparatus 1 identifies the clusters to which the respective cases acquired from the search belong, respectively acquires the labels and the representative cases of the cluster for each of the clusters, and classifies the acquired labels and representative cases for each cluster and displaying the classified labels and representative cases on the display device 8.

As means for realizing the foregoing case clustering function and optimal case acquisition function, the memory 3 of the relevant information acquisition apparatus 1 stores a case management unit 11, a characteristic term extraction unit 12, an input document reception unit 13, a case search unit 14 and a search result display unit 15, and the storage device 4 of the relevant information acquisition apparatus 1 stores inter-case relevant information 18, cluster information 19 and dictionary information 20 as described above.

The case management unit 11 is a program with a function of detecting a relevance among cases in which the conversation history documents are stored in the case storage unit 17 of the storage device 4, and is configured from an inter-case relevance detection unit 30 and a cluster creation unit 31.

The inter-case relevance detection unit 30 is a module with a function of calculating the similarity of cases, detecting cases with a relevance based on the calculated similarity, and storing the detected cases with a relevance in the inter-case relevant information 18. Moreover, the cluster creation unit 31 is a module with a function of classifying the respective cases into a plurality of clusters, which are an aggregate of the cases of high relevance, based on the relevance among the cases detected by the inter-case relevance detection unit 30. The cluster creation unit 31 also comprises a function of assigning terms, as labels, which characterize the cluster to that cluster for each of the clusters as well as extracting representative cases, and storing the extraction result in the cluster information 19.

Furthermore, the characteristic term extraction unit 12 is a program with a function of extracting characteristic terms from the conversation history documents of the respective cases stored in the case storage unit 17 of the storage device 4, and the inquiry text representing the inquiry content from the customer that was input by the user. The characteristic term extraction unit 12 extracts the respective characteristic terms from the conversation history documents of the respective cases and the inquiry text of the new inquiry by using the same dictionary.

The input document reception unit 13 is a program with a function of receiving the inquiry text that was input by the user.

The case search unit 14 is a program with a function as a case acquisition unit which searches and acquires the optimal cases in relation to the inquiry text that was input by the user, and is configured from a search execution unit 32, a cluster identification unit 33 and a representative case acquisition unit 34.

The search execution unit 32 is a module with a function of searching and acquiring the optimal cases in relation to the inquiry text received by the input document reception unit 13 among the cases stored in the case storage unit 17. Moreover, the cluster identification unit 33 is a module with a function of identifying the clusters to which the respective cases acquired by the search execution unit 32 belong, and assigning terms, as labels, which characterize the cluster to that cluster, and the representative case acquisition unit 34 is a module with a function of acquiring the representative cases of each cluster that was identified by the cluster identification unit 33.

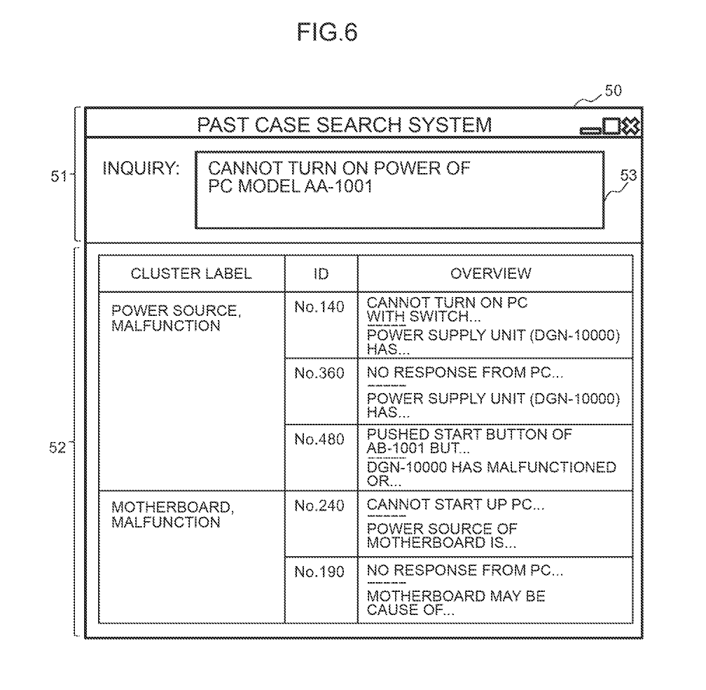

Furthermore, the search result display unit 15 is a program with a function of generating a result output screen 50, which is described later with reference to FIG. 6, containing information such as the labels and representative cases of the clusters acquired as described above, and displaying the generated result output screen 50 on the display device 8.

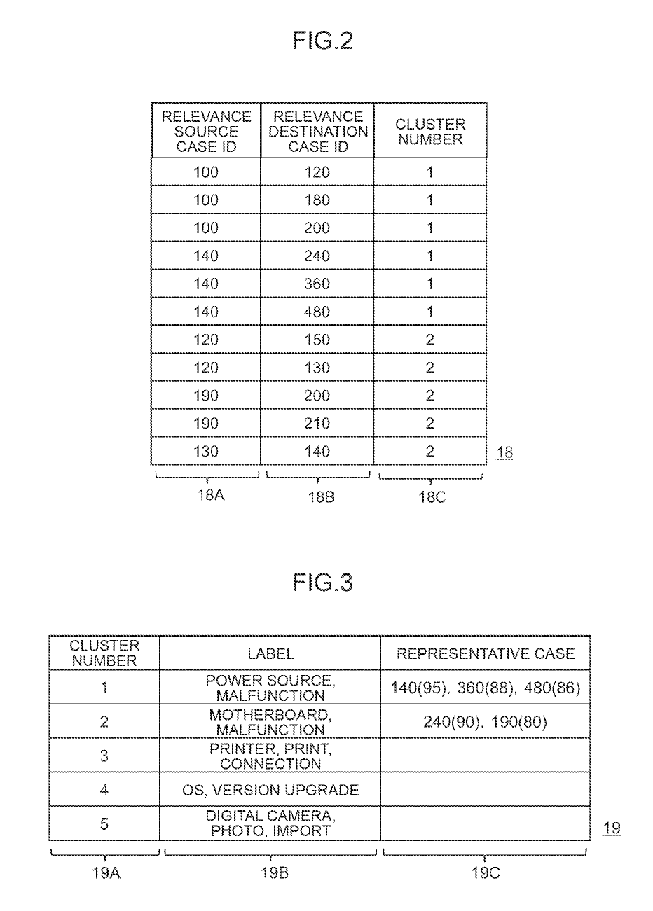

Meanwhile, the inter-case relevant information 18 is information for managing the relevance among the cases detected by the inter-case relevance detection unit 30 of the case management unit 11, and the clusters in which the respective cases are classified by the cluster creation unit 31 of the case management unit 11, and has a table structure comprising, as shown in FIG. 2, a relevance source case ID column 18A, a relevance destination case ID column 18B and a cluster number column 18C.

The relevance source case ID column 18A stores the identifier assigned to each of the cases in which the conversation history documents are stored in the case storage unit 17 of the storage device 4 (this is hereinafter referred to as the “case ID”), and the relevance destination case ID column 18B stores the case ID of the case that was determined by the inter-case relevance detection unit 30 as having a relevance with the cases in which the case ID is stored in the corresponding relevance source case ID column 18A. Moreover, the cluster number column 18C stores the identification number assigned to the cluster to which belong the cases in which the case ID is stored in the corresponding relevance source case ID column 18A and the cases in which the case ID is stored in the corresponding relevance destination case ID column 18B (this is hereinafter referred to as the “cluster number”).

Accordingly, in the case of the example of FIG. 2, the case identified with the case ID of “100” has a relevance with the respective cases identified with the case ID of “120”, “180” and “200”, and the respective cases identified with the case ID of “100”, “120”, “180” and “200” respectively belong to the cluster to which “1” is assigned as the cluster number.

Furthermore, the cluster information 19 is information for managing the clusters created by the cluster creation unit 31, and has a table structure comprising, as shown in FIG. 3, a cluster number column 19A, a label column 19B and a representative case column 19C. The cluster number column 19A stores the cluster number of each cluster created by the cluster creation unit 31, and the label column 19B stores the labels assigned to the corresponding cluster. Moreover, the representative case column 19C stores the case ID of each case extracted as the representative cases of the corresponding cluster and the score (described later) of those cases in ascending order from the largest score.

Accordingly, in the case of the example of FIG. 3, there are currently five clusters to which “1” to “5” are respectively assigned as the cluster number, and, for example, the cluster identified with the cluster number of “1” is assigned the labels of “power source” and “malfunction”, the cluster identified with the cluster number of “2” is assigned the labels of “motherboard” and “malfunction”, the representative cases of the cluster number “1” are identified with the case ID of “140”, “360” and “480”, and cases having the respective scores of “95”, “88” and “86” have been extracted.

The dictionary information 20 is information representing the dictionary that is used when the characteristic term extraction unit 12 extracts characteristic terms from the conversation history documents of past cases, or from the inquiry text representing the contents of a new inquiry from a customer. The dictionary information 20 is configured from technical term information 35 and search history information 36.

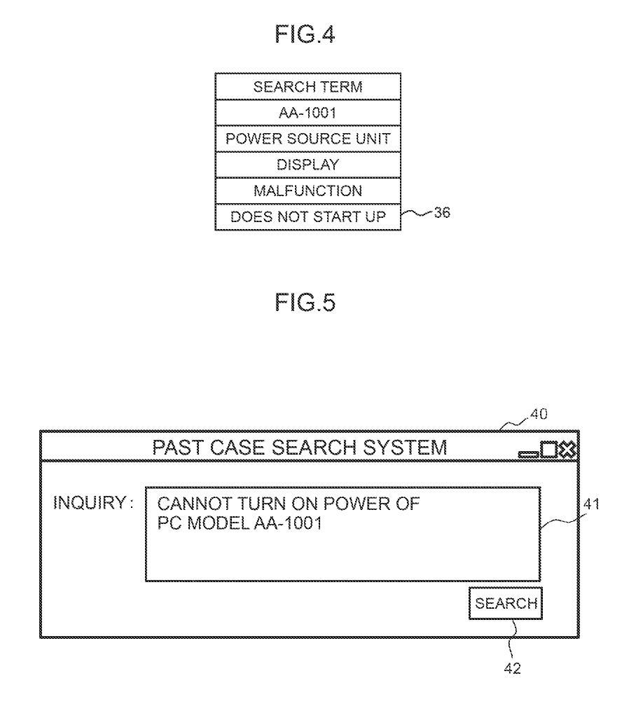

The technical term information 35 is information related to a dictionary containing technical terms which are terms that appear as keywords in a manual of a target product or in documents of a field related to that product (this is hereinafter referred to as the “technical term dictionary”), and the search history information 36 is information related to a dictionary containing terms that were used as keywords during the search processing of cases of an inquiry content similar to the inquiry text that was previously executed as shown in FIG. 4 (this is hereinafter referred to as the “search history dictionary”). The technical term dictionary contains, for example, terms that are indicated in the index of the manual of the target product, and the search history dictionary contains, for example, terms that are registered in the search history dictionary of other relevant information acquisition apparatuses 1 that are being operated.

### (1-3) Configuration of Various Screens

FIG. 5 shows a configuration example of the inquiry text input screen 40 that may be displayed on the display device 8 of the relevant information acquisition apparatus 1 based on predetermined operations. The inquiry text input screen 40 is a screen for the user, in a call center or the like, to input an inquiry text corresponding to an inquiry from a customer as the search target, and is configured from an inquiry text-text box 41 and a search button 42.

On the inquiry text input screen 40, as a result of the user operating the input device 7 and inputting the inquiry text in the inquiry text-text box 41 and thereafter clicking the search button 42, that user can thereby instruct the relevant information acquisition apparatus 1 to conduct a search with that inquiry text as the search target.

Moreover, FIG. 6 shows a configuration example of the result output screen 50 that is displayed on the display device 8 a short while after the search button 42 of the inquiry text input screen 40 is clicked. The result output screen 50 is a screen for displaying the processing result of the search processing of the optimal case in relation to the inquiry text which was executed in the relevant information acquisition apparatus 1 based on the foregoing search instruction, and is configured by comprising an inquiry text display field 51 and a result display field 52.

The inquiry text display field 51 is provided with an inquiry text display column 53, and an inquiry target of the search target is displayed in the inquiry text display column 53 (inquiry text that was input by the user in the inquiry text-text box 41 of the inquiry text input screen 40).

Furthermore, in the result display field 52, displayed in the form of a list are the labels assigned to the cluster, the case ID of the representative cases of that cluster, and a part or all of the conversation history document of the representative casess by being classified into clusters to which belong each of the optimal cases in relation to the inquiry text which were detected as a result of the search processing. Here, the conversation history documents of the representative cases are displayed in ascending order from the largest score of the corresponding representative case described above with reference to FIG. 3.

Accordingly, in the case of the example of FIG. 6, in response to the inquiry text of “cannot turn on power of PC model AA-1001”, the cluster identified with the labels of “power source” and “malfunction” and the cluster identified with the labels of “motherboard” and “malfunction” have been detected as the clusters to which cases of the inquiry content similar to the inquiry text belong.

Furthermore, in FIG. 6, for example, with regard to the cluster identified with the labels of “power source” and “malfunction”, the cases identified with the case ID of “140”, “360” and “480” have been determined to be the representative cases, and, among the above, the contents of the conversation history document of the case identified with the case ID of “140” are “cannot turn on PC with switch . . . power supply unit (DGN-10000) has . . . ”

### (1-4) Various Types of Processing Related to Case Clustering Function and Optimal Case Acquisition Function

The specific processing contents of the various types of processing to be executed in the relevant information acquisition apparatus 1 in relation to the foregoing case clustering function and optimal case acquisition function are now explained. Note that, in the ensuing explanation, while the processing entity of the various types of processing is explained as a “program” or a “module”, it goes without saying that, in effect, the CPU 2 (FIG. 1) of the relevant information acquisition apparatus 1 executes the processing based on such “program” or “module”.

### (1-4-1) Inter-Case Relevance Detection Processing

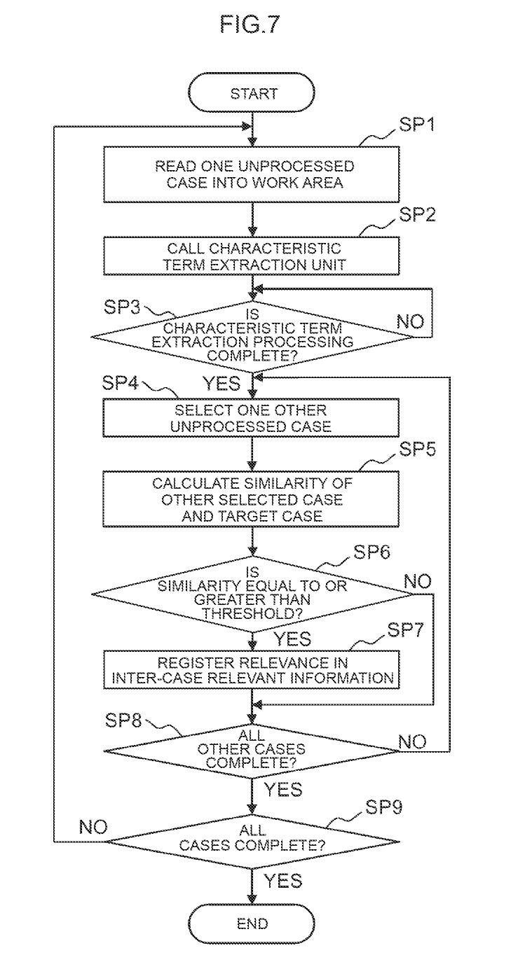

FIG. 7 shows the specific processing routine of the inter-case relevance detection processing to be executed by the inter-case relevance detection unit 30 (FIG. 1) of the relevant information acquisition apparatus 1 in relation to the foregoing case clustering function. The inter-case relevance detection processing is periodically executed, or randomly executed upon receiving the processing execution instruction from the user.

When the inter-case relevance detection unit 30 starts the inter-case relevance detection processing, the inter-case relevance detection unit 30 foremost reads, into the work area of the memory 3, the conversation history document of one case among the cases in which the conversation history documents are stored in the case storage unit 17 of the storage device 4 (SP1). Subsequently, the inter-case relevance detection unit 30 calls the characteristic term extraction unit (SP2), and thereafter waits for the characteristic terms of the case in which the conversation history document was read into the work area 16 (this is hereinafter referred to as the “target case”) to be extracted by the characteristic term extraction unit 12 (FIG. 1) (SP3).

When the characteristic terms of the target case are eventually notified by the characteristic term extraction unit 12 as described later, the inter-case relevance detection unit 30 select one other case that is different from the target case among the cases in which the conversation history documents are stored in the case storage unit 17 (SP4). Moreover, the inter-case relevance detection unit 30 compares the character components of the conversation history document of the other case selected in step SP4 (this is hereinafter referred to as the “other selected case”) and the characteristic terms notified by the characteristic term extraction unit 12 in step SP3 (concept search), and calculates the similarity between the other selected case and the target case (SP5).

Subsequently, the inter-case relevance detection unit 30 determines whether the similarity calculated in step SP5 is equal to or greater than the foregoing similarity threshold (SP6). When the inter-case relevance detection unit 30 obtains a negative result in the foregoing determination, the inter-case relevance detection unit 30 proceeds to step SP8.

Meanwhile, when the inter-case relevance detection unit 30 obtains a positive result in the determination of step SP6, the inter-case relevance detection unit 30 registers the relevance of the target case and the other selected case in the inter-case relevant information 18 (FIG. 2) (SP7). Specifically, the inter-case relevance detection unit 30 stores the case ID of the target case in the relevance source case ID column 18A of the inter-case relevant information 18, and stores the case ID of the other selected case in the relevance destination case ID column 18B of the same line as the relevance source case ID column 18A.

Next, the inter-case relevance detection unit 30 determines whether the processing of step SP5 to step SP7 has been executed for all cases other than the target case (SP8). When the inter-case relevance detection unit 30 obtains a negative result in the foregoing determination, the inter-case relevance detection unit 30 returns to step SP4, and thereafter repeats the processing of step SP4 to step SP8 while sequentially switching the case selected in step SP4 to another unprocessed case other than the target case.

When the inter-case relevance detection unit 30 eventually obtains a positive result in step SP8 as a result of executing the processing of step SP5 to step SP7 for all cases other than the target case, the inter-case relevance detection unit 30 determines whether the processing of step SP2 to step SP8 has been executed for all cases in which the conversation history documents are stored in the case storage unit 17 (SP9). When the inter-case relevance detection unit 30 obtains a negative result in the foregoing determination, the inter-case relevance detection unit 30 returns to step SP1, and thereafter repeats the processing of step SP1 to step SP8 while switching the case, in which the conversation history document is to be read into the work area 16 of the memory 3 in step SP1, to another unprocessed case.

When the inter-case relevance detection unit 30 eventually obtains a positive result in step SP9 as a result of executing the processing of step SP2 to step SP8 for all cases, the inter-case relevance detection unit 30 ends the inter-case relevance detection processing, and thereafter calls the cluster creation unit 31.

### (1-4-2) Characteristic Term Extraction Processing

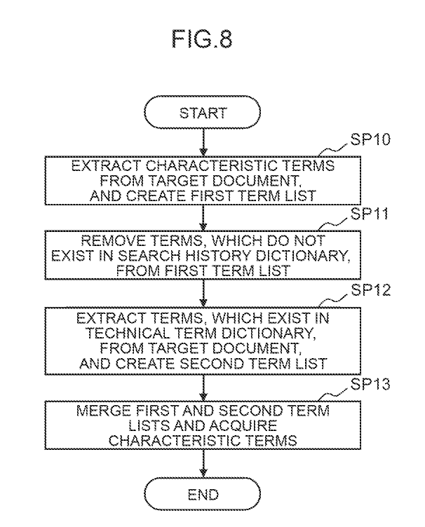

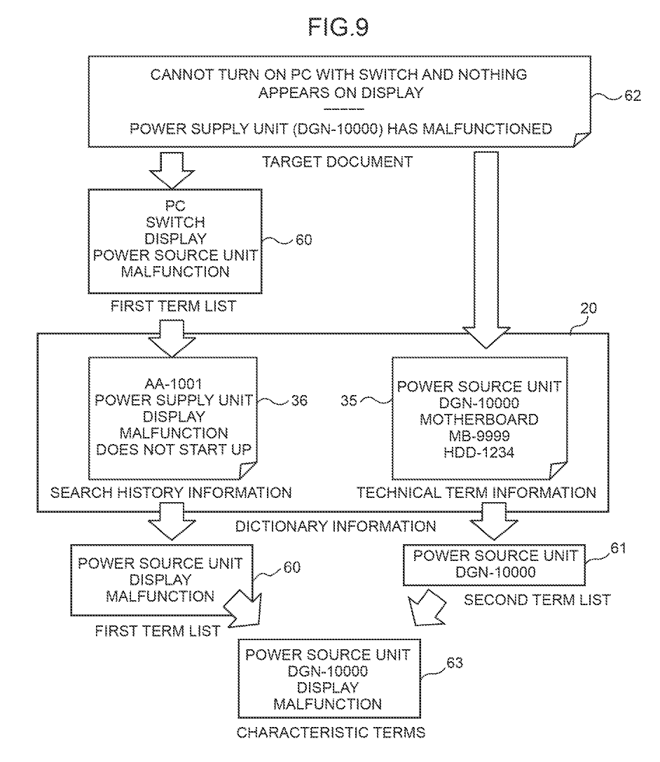

FIG. 8 shows the specific processing routine of the characteristic term extraction processing to be executed by the characteristic term extraction unit 12 that was called by the inter-case relevance detection unit 30 in step SP2 of the foregoing inter-case relevance detection processing, and FIG. 9 shows the overview of the characteristic term extraction processing.

When the characteristic term extraction unit 12 is called by the inter-case relevance detection unit 30, the characteristic term extraction unit 12 starts the characteristic term extraction processing shown in FIG. 8, and foremost extracts all terms (for instance, terms with a high frequency of appearance) that characterize the target document 62 from the target document (here, the conversation history document of the target case) 62 by using a statistical technique such as the TF-IDF (Term Frequency-Inverse Document Frequency), and creates a first term list 60 (FIG. 9) containing the extracted terms in the work area 16 of the memory 3 (SP10).

Subsequently, the characteristic term extraction unit 12 compares the first term list 60 and the search history dictionary (search history information 36), which is one type of dictionary information, and deletes, from the first term list 60, the terms that do not exist in the search history dictionary (search history information 36) (SP11).

Based on this processing, it is possible to eliminate terms that have not been used in previous searches among the terms that characterize the target document 62 which were extracted with the statistical technique. For instance, terms that are included in expressions such as “I hope all is well” and “Kind regards” that often appear in emails, and noises such as the company name and personal name included in the email signature, which are unrelated to the reply to the inquiry, can be eliminated. Note that, by additionally adding information such as the usage count and date (data collection period) to the search history information 36, it is also possible to adopt a technique of leaving terms in which the usage count is in the top several ten % (for instance, top 30%), or adopt a technique of leaving terms in which the usage count is 100 times or more within a predetermined period.

Next, the characteristic term extraction unit 12 compares the target document 62 and the technical term dictionary (technical term information 35), which is one type of dictionary information, extracts all terms contained in both the target document 62 and the technical term dictionary (technical term information 35), and creates a second term list 61 (FIG. 9) containing the extracted terms in the work area 16 of the memory 3 (SP12).

Based on this processing, it is possible to extract terms that are meaningful for the target document 62, even though such terms could not be extracted with the statistical technique because the frequency of appearance of such terms was extremely low. Moreover, terms related to the functions and other matters of a new product are unlikely to be included in the search history dictionary (search history information 36). Thus, it is anticipated that many of such terms will be excluded in the processing of step SP11, but based on the processing of step SP12, it will be possible to extract such terms that characterize the target document 62.

Subsequently, the characteristic term extraction unit 12 combines (merges) the first term list 60 created in step SP10 and the second term list 61 created in step SP12, and acquires the terms registered in the respective first and second term lists 60, 61 as the characteristic terms 63 of the target document 62 (SP13).

Note that, rather than just simply combining the first and second term lists 60, 61, it is also possible to combine the first and second term lists 60, 61 by applying weight to the more important first or second term list 60, 61 in order to attach important to either the first or second term list 60, 61 (for example, it is possible to combine the terms respectively registered in the first and second term lists 60, 61 so that the ratio of the terms registered in the first term list 60 and the terms registered in the second term list 61 will be 10:8).

The characteristic term extraction unit 12 thereafter ends the characteristic term extraction processing, and notifies the characteristic terms 63 of the target document 62 obtained as described above to the inter-case relevance detection unit 30.

As a result of using a technical term dictionary in addition to a search history dictionary as described above, it is possible to prevent the omission of terms that are clearly related to that product or field.

### (1-4-3) Cluster Creation Processing

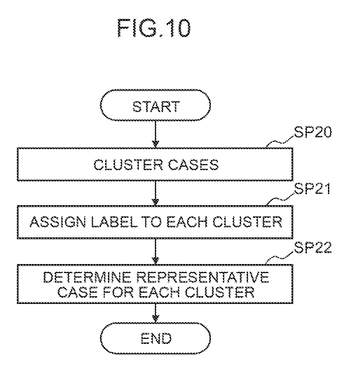

FIG. 10 shows the specific processing routine of the cluster creation processing to be executed by the cluster creation unit 31 (FIG. 1) that was called by the inter-case relevance detection unit 30 after the end of the inter-case relevance detection processing described above with reference to FIG. 7.

When the cluster creation unit 31 is called by the inter-case relevance detection unit 30, the cluster creation unit 31 starts the cluster creation processing shown in FIG. 10, and foremost executes clustering processing of classifying the cases with relevance into the same cluster by using the inter-case relevant information 18 (FIG. 2) created in the previous inter-case relevance detection processing (SP20).

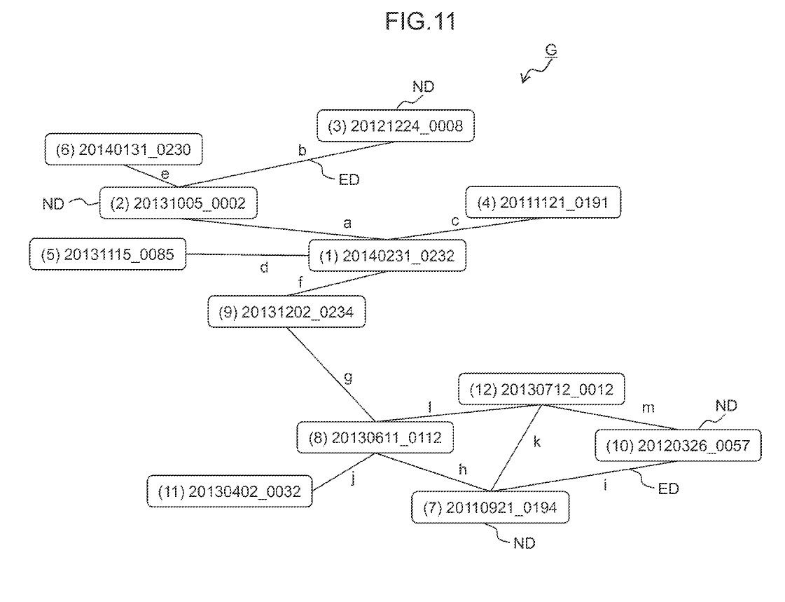

In effect, the cluster creation unit 31 foremost refers to the inter-case relevant information 18 and creates a graph G as shown in FIG. 11. The graph G is created by connecting, among the nodes ND associated with each of the cases, the cases that are registered as cases with relevance in inter-case relevant information 18 with a line referred to as an edge ED.

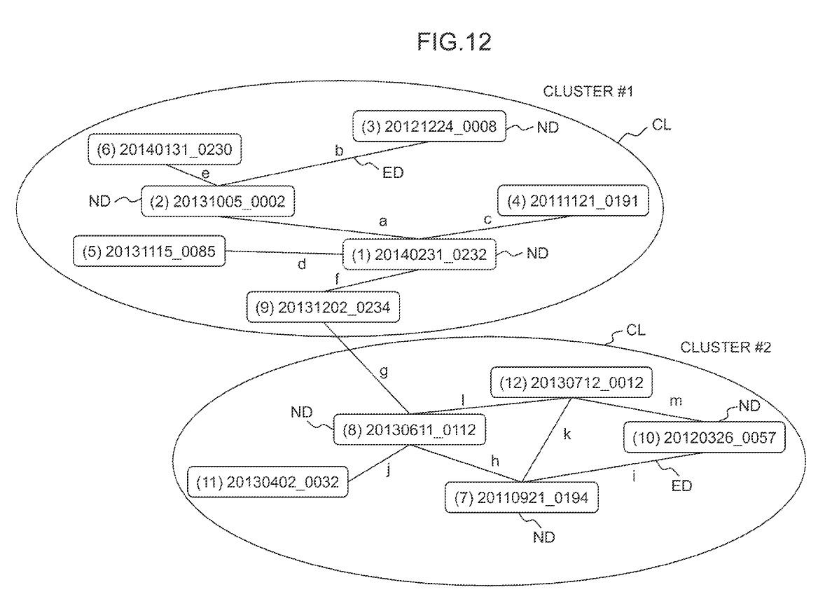

Furthermore, the cluster creation unit 31 classifies the respective cases into a plurality of clusters CL as shown in FIG. 12 by applying a general clustering technique, such as the k-means technique, to the created graph G to classify the respective cases based on the characteristic terms of the respective cases, and assigns a cluster number to each of the clusters CL.

Subsequently, the cluster creation unit 31 assigns labels, which characterize the cluster CL, to each cluster CL created in step SP20 (SP21). Specifically, the cluster creation unit 31 collects, for each of the clusters CL, the data of the characteristic terms of the respective cases belonging to that cluster CL, and assigns the top few terms (for example, the top 10 terms) among the characteristic terms that are common to many of the cases to the cluster CL as the labels of that cluster CL. Subsequently, the cluster creation unit 31 associates the labels assigned to the respective clusters CL and the cluster number of the corresponding cluster CL, and stores the result in the cluster information 19 (FIG. 3).

Next, the cluster creation unit 31 determines the representative cases of the cluster CL for each of the clusters CL, and registers the representative cases that were determined for each cluster in the cluster information 19 (SP22). Specifically, the cluster creation unit 31 determines, as the representative cases of the cluster CL for each of the clusters CL classified as shown in FIG. 12, the top few (for example, top three) cases among the cases with high mutual relevance (degree centrality is high in the graph theory) within the cluster CL belonging to that cluster. Subsequently, the cluster creation unit 31 stores the case ID and stores of the representative cases that were determined for each cluster in the corresponding representative case column 19C (FIG. 3) of the cluster information 19, in ascending order from the largest score, and thereafter ends the cluster creation processing.

### (1-4-4) Optimal Case Acquisition Processing

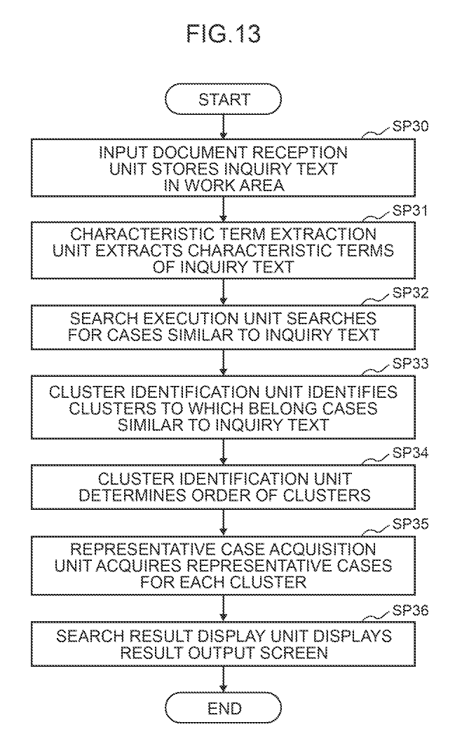

Meanwhile, FIG. 13 shows the specific processing routine of the optimal case acquisition processing to be executed in the relevant information acquisition apparatus 1 in relation to the foregoing optimal case acquisition function. The optimal case acquisition processing is executed upon receiving a search instruction from the user.

In effect, the relevant information acquisition apparatus 1 starts the optimal case acquisition processing when the inquiry text corresponding to an inquiry from a customer is input to the inquiry text-text box 41 of the inquiry text input screen 40 described above with reference to FIG. 5 and the search button 42 is subsequently clicked, and the input document reception unit 13 (FIG. 1) foremost retrieves the inquiry text input to the inquiry text input screen 40 and stores the retrieved inquiry text in the work area 16 of the memory 3 (SP30). The input document reception unit 13 thereafter calls the characteristic term extraction unit 12 (FIG. 1).

When the characteristic term extraction unit 12 is called by the input document reception unit 13, the characteristic term extraction unit 12 executes the characteristic term extraction processing described above with reference to FIG. 8 and thereby extracts the characteristic terms, which characterize the inquiry text, from that inquiry text (SP31). Specifically, the characteristic term extraction unit 12 executes the characteristic term extraction processing of FIG. 8 with the “target document” as the “inquiry text” in step SP31. Here, the characteristic term extraction unit 12 extracts the characteristic terms of the inquiry text by using the same dictionary information 20 as the one used for extracting the characteristic terms of the respective cases stored in the case storage unit 17 of the storage device 4. The characteristic term extraction unit 12 thereafter calls the search execution unit 32 (FIG. 1) of the case search unit 14, and notifies the obtained characteristic terms of the inquiry text to the search execution unit 32.

When the search execution unit 32 is called by the characteristic term extraction unit 12, the search execution unit 32 performs a concept search of the optimal cases related to the inquiry text based on the characteristic terms of the inquiry text notified by the characteristic term extraction unit 12 and the conversation history documents of the respective cases (SP32). The search execution unit 32 thereafter calls the cluster identification unit 33 (FIG. 1), and notifies the case ID of all detected cases to the cluster identification unit 33.

When the cluster identification unit 33 is called by the search execution unit 32, the cluster identification unit 33 refers to the inter-case relevant information 18 (FIG. 2), and identifies the clusters to which belong the respective cases in which the case ID was notified by the search execution unit 32 (SP33). Moreover, the cluster identification unit 33 determines the ranking of the respective clusters identified in step SP33 (SP34). For example, the cluster identification unit 33 determines, as the top clusters, clusters in which more of the top several ten (for example, 20) cases detected in the search of step SP32 belong. The cluster identification unit 33 thereafter calls the representative case acquisition unit 34 (FIG. 1), and notifies the cluster ID and ranking of the identified clusters to the representative case acquisition unit 34.

When the representative case acquisition unit 34 is called by the cluster identification unit 33, the representative case acquisition unit 34 acquires, from the cluster information 19 (FIG. 3), the case ID of the representative cases of the respective clusters identified by the cluster identification unit 33 (SP35). The representative case acquisition unit 34 thereafter calls the search result display unit 15 (FIG. 1), and notifies the cluster ID of the respective clusters notified by the cluster identification unit 33 and the case ID of the respective case of each of the clusters and the ranking of the respective clusters to the search result display unit 15.

When the search result display unit 15 is called by the representative case acquisition unit 34, the search result display unit 15 generates the result output screen 50 described above with reference to FIG. 6 based on the cluster ID of the respective clusters notified by the representative case acquisition unit 34 and the case ID of the representative cases of each of the clusters (SP36).

Specifically, the search result display unit 15 acquires the labels of the clusters from the cluster information 19 based on the cluster ID of the respective clusters notified by the representative case acquisition unit 34, and reads, from the case storage unit 17, the conversation history documents of the respective cases to which the case ID was assigned based on the case ID of the representative cases of each of the clusters notified by the representative case acquisition unit 34. Subsequently, the representative case acquisition unit 34 generates the result output screen 50 based on the thus obtained information. Here, the search result display unit 15 generates the result output screen 50 so that information of a higher ranking cluster is displayed before the information of other clusters. The search result display unit 15 thereafter displays the thus generated result output screen 50 on the display device 8.

The relevant information acquisition apparatus 1 thereafter ends the optimal case acquisition processing.

(1-5) Effect of this Embodiment

As described above, with the relevant information acquisition apparatus 1 of this embodiment, the optimal cases related to the inquiry text are classified into a plurality of clusters, which are an aggregate of cases with high relevance, and, for each of the clusters, the labels which characterize that cluster and a part or all of the conversation history document of the representative cases are displayed.

Thus, according to the relevant information acquisition apparatus 1, the user can find optimal cases in reply to the inquiry from a customer in a short period of time and, consequently, the work efficiency of that user can be dramatically improved.

### (2) Second Embodiment

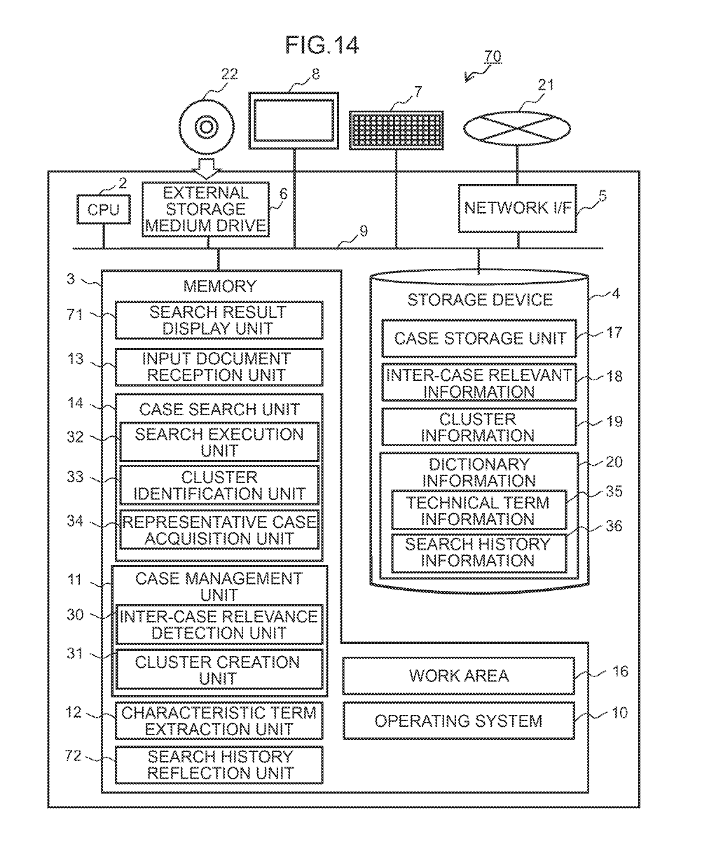

FIG. 14, in which the same reference numeral is assigned to the same component as those depicted in FIG. 1, shows the relevant information acquisition apparatus 70 according to the second embodiment. The relevant information acquisition apparatus 70 is configured in the same manner as the relevant information acquisition apparatus of the first embodiment excluding the point that, after the search processing of optimal cases in relation to the inquiry text is executed, search processing can be executed once again using a keyword input by the user as a new keyword.

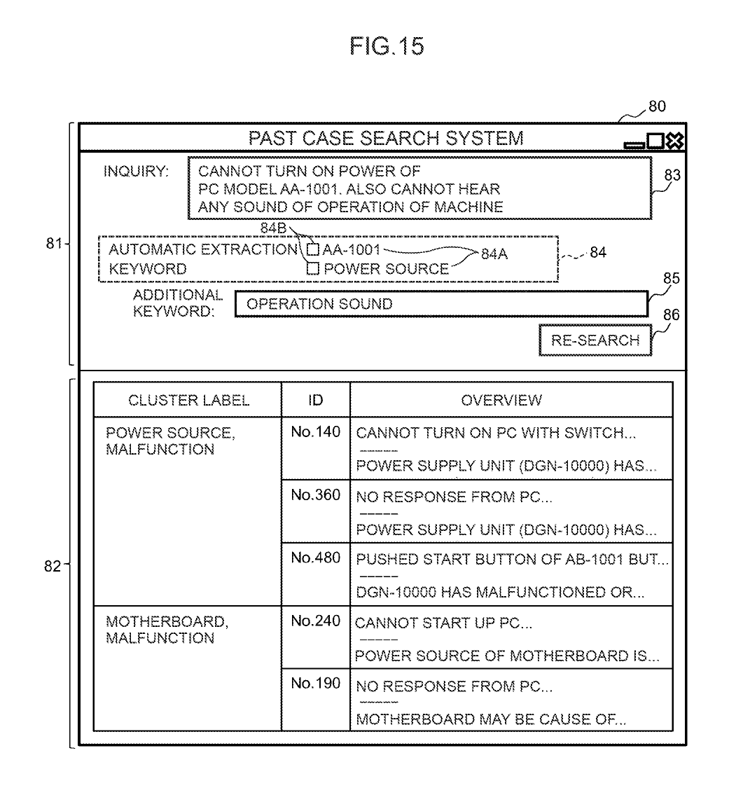

FIG. 15 shows the configuration example of the result output screen 80 to be displayed on the display device 8 by the search result display unit 71 (FIG. 14) of the relevant information acquisition apparatus 70 according to this embodiment in substitute for the result output screen 50 described above with reference to FIG. 6. The result output screen 80 is configured from an inquiry text display field 81 and a result display field 82, and the result display field 82 is configured in the same manner as the result display field 52 (FIG. 6) of the result output screen 50 (FIG. 6) of the first embodiment.

Meanwhile, the inquiry text display field 81 comprises an automatic extraction keyword field 84, an additional keyword text box 85 and a re-search button 86 in addition to the inquiry text display column 83 having the same configuration and function as the inquiry text display column 53 (FIG. 6) provided to the inquiry text display field 51 (FIG. 6) of the result output screen 50 of the first embodiment.

The automatic extraction keyword field 84 displays character strings 84A respectively representing the keywords used in the search processing of step SP32 of the optimal case acquisition processing described above with reference to FIG. 13 (corresponding to the characteristic terms of the inquiry text extracted from the inquiry text by the characteristic term extraction unit 12 in step SP31), and a check box 84B is displayed in correspondence with each of the character strings 84A. A check mark (not shown) can be displayed in the check box 84B by clicking the check box 84B.

Furthermore, in the additional keyword text box 85, the user may input, via the input device 7 (FIG. 1), a new keyword other than the keywords that were used in the previous search and displayed in the automatic extraction keyword field 84 to be used when executing a re-search.

Consequently, the user can display a check mark in the check box 84B corresponding to the intended keyword among the keywords used in the previous search processing displayed in the automatic extraction keyword field 84 and additionally input an intended new keyword in the additional keyword text box 85 and thereafter click the re-search button 86 so as to execute a re-search of the cases of the inquiry content that is similar to the inquiry text by using the keyword in which a check mark is displayed in the corresponding check box 84B of the automatic extraction keyword field 84 and the new keyword input in the additional keyword text box 85. The keyword that is input in the keyword text box 85 is added to the characteristic terms of the inquiry text, and a re-search is thereby executed.

Meanwhile, as shown in FIG. 14, the memory 3 of the relevant information acquisition apparatus 70 stores a search history reflection unit 72 in addition to the search result display unit 71, the input document reception unit 13, the case search unit 14, the case management unit 11 and the characteristic term extraction unit 12. The search history reflection unit 72 is a program with a function of additionally registering the keyword, which was input in the additional keyword text box 85 of the result output screen 80 of this embodiment described above with reference to FIG. 15, in the search history dictionary (search history information 36).

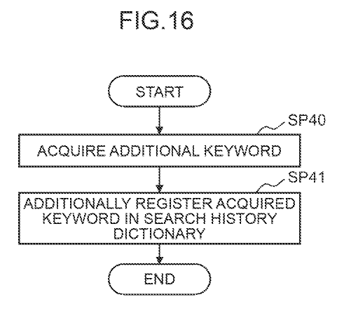

In effect, when a new keyword is input to the additional keyword text box 85 and the re-search button 86 is thereafter clicked on the result output screen 80, the search history reflection unit 72 foremost acquires the new keyword that was input to the additional keyword text box 85 of the result output screen 80 (SP40) and then additionally registers the acquired keyword in the search history dictionary (search history information 36) (SP41) according to the processing routine shown in FIG. 16.

Note that, with the relevant information acquisition apparatus 70, while the processing of step SP32 onward of the optimal case acquisition processing described above with reference to FIG. 13 will be subsequently executed as the re-search processing, here, in step SP32, the search execution unit 32 (FIG. 14) of the case search unit 14 (FIG. 14) will execute search processing using the new keywords designated by the user in the result output screen 80 (keywords din which a check mark is displayed in the corresponding check box 84B in the automatic extraction keyword field 84 and the keyword input to the additional keyword text box 85).

According to the relevant information acquisition apparatus 70 of this embodiment having the foregoing configuration, since the keywords input by the user are sequentially accumulated in the search history dictionary (search history information 36), it is possible to perform a highly accurate search which reflects the user's search policy in the search processing of searching for the optimal cases related to the inquiry text. According to the relevant information acquisition apparatus 70, the user can find optimal cases in reply to the inquiry from a customer in a short period of time and, consequently, the work efficiency of that user can be dramatically improved.

### (3) Third Embodiment

In FIG. 1, reference numeral 90 represents the overall relevant information acquisition apparatus according to the third embodiment. The relevant information acquisition apparatus 90 is configured in the same manner as the relevant information acquisition apparatus 1 according to the first embodiment excluding the point that the configuration of the characteristic term extraction unit 91 is different.

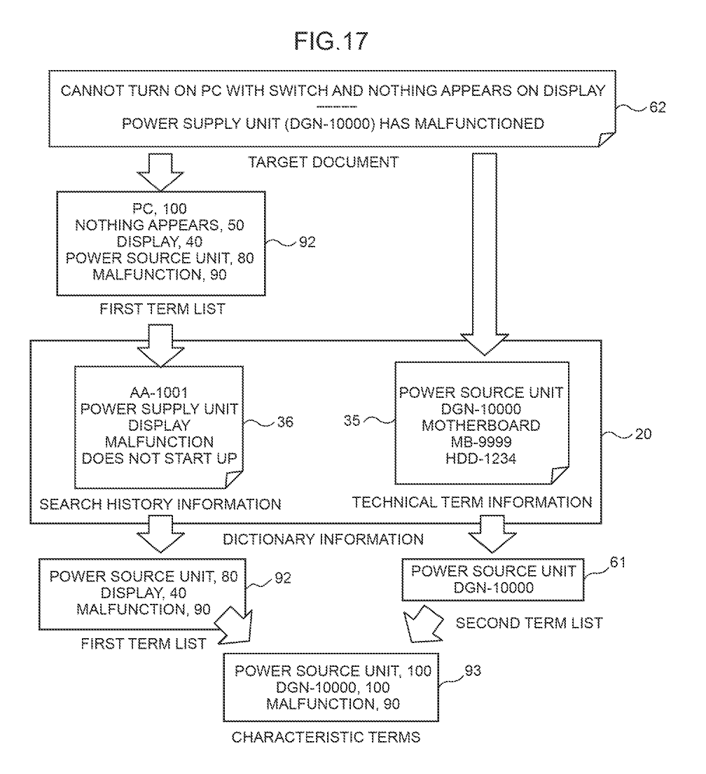

FIG. 17 shows the overview of the characteristic term extraction processing described above with reference to FIG. 8 and FIG. 9 to be executed by the characteristic term extraction unit 91 of the relevant information acquisition apparatus 90. The point that is different from the characteristic term extraction processing of the first embodiment is that, when the characteristic term extraction unit 91 creates the first term list 92 in step SP10 of the characteristic term extraction processing (FIG. 8) and ultimately determines the characteristic terms 93 in step SP13 of the characteristic term extraction processing, scores (numerical values added after the terms in FIG. 17) are assigned to the terms that are registered in the first term list 92 and to the ultimately acquired characteristic terms 93. As the score, applied may be the frequency of appearance of that term which is obtained in the processing using a statistical technique, such as TF-IDF, which is used upon creating the first term list 92 in step SP10 of the characteristic term extraction processing of FIG. 8.

Furthermore, since the terms registered in the second term list 61 are terms that are deemed to be more important terms extracted from the technical term dictionary (technical term information), a fixed value is assigned. In this embodiment, let it be assumed that “100”, which is the maximum value of the score, is assigned to the terms that are registered in the second term list 61 (refer to “characteristic term 94” of FIG. 17). However, the score of the terms registered in the second term list 61 may also be a variable value according to the frequency of appearance of that term.

Furthermore, the characteristic term extraction unit 91 combines the terms registered in the first and second term lists 92, 61 by giving consideration to the score of the respective terms registered in the first and second term lists 92, 61 upon merging the first and second term lists 92, 61 in step SP13 of the characteristic term extraction processing (FIG. 8). For example, upon combining the terms registered in the first and second term lists 92, 61, the characteristic term extraction unit 91 ultimately extracts the characteristic terms of the inquiry text upon deleting the terms having a score that is equal to or less than a predetermined value (for instance, 50).

According to the relevant information acquisition apparatus 90 of this embodiment having the foregoing configuration, since more selected terms can be extracted as the characteristic terms upon extracting the characteristic terms of past cases or the inquiry text, it is possible to detect more selected cases as the optimal cases related to the inquiry text. According to the relevant information acquisition apparatus 90, the user can find optimal cases in reply to the inquiry from a customer in a short period of time and, consequently, the work efficiency of that user can be dramatically improved.

### (4) Fourth Embodiment

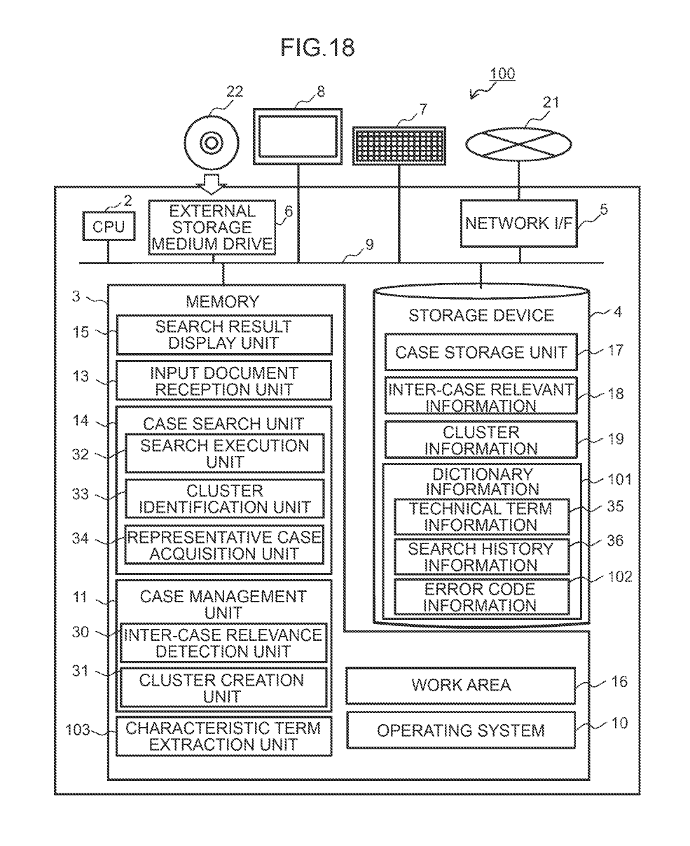

FIG. 18, in which the same reference numeral is assigned to the same component as those depicted in FIG. 1, shows the relevant information acquisition apparatus 100 according to the fourth embodiment. The relevant information acquisition apparatus 100 is configured in the same manner as the relevant information acquisition apparatus 1 of the first embodiment excluding the point that, when an error code is included in the target document (inquiry text in this example; hereinafter the same), the error code can be extracted from the target document as one of the characteristic terms.

In effect, with the relevant information acquisition apparatus 100 of this embodiment, the storage device 4 stores, as the dictionary information 101, error code information 102 describing a rule of the error code of the corresponding model (for example, “5-digit number after ERR-”) in addition to the technical term information 35 as the information of the technical term dictionary, and the search history information 36 as the information of the search history dictionary that was created based on the search history.

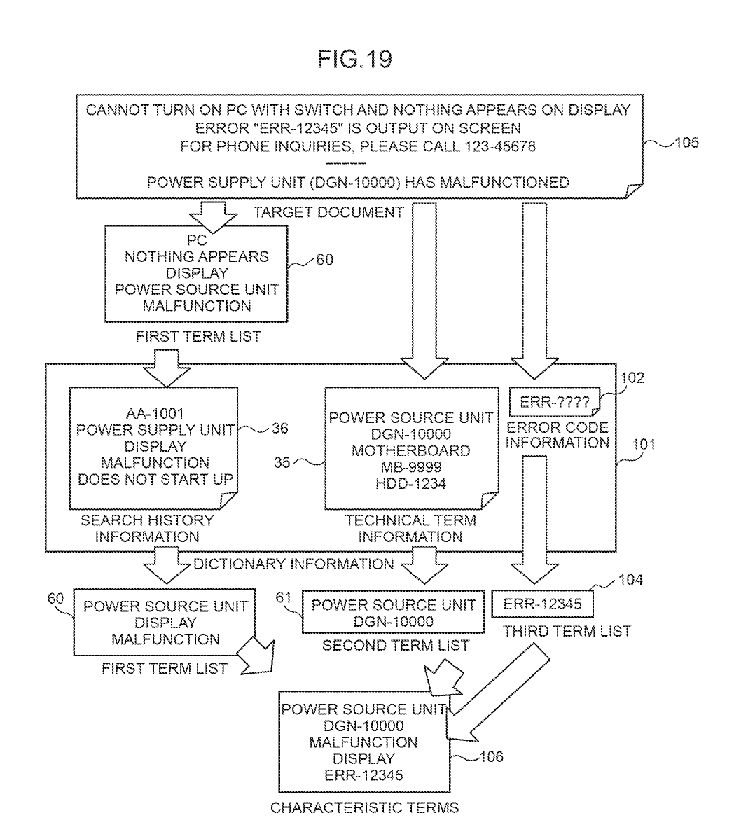

In step SP31 of the optimal case acquisition processing described above with reference to FIG. 13, in cases where an error code is included in the target document 105, as shown in FIG. 19, the characteristic term extraction unit 103 extracts that error code from the target document 105 by using the error code information 102 in addition to performing the same processing as the characteristic term extraction processing of the first embodiment described above with reference to FIG. 8 and FIG. 9. Moreover, the characteristic term extraction unit 103 creates a third term list 104 containing the extracted error codes, combines (merges) the first to third term lists 60, 61, 104, and thereby extracts the characteristic terms 106 of the target document 105.

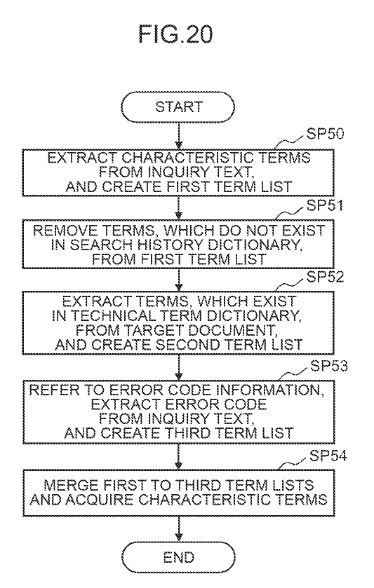

FIG. 20 shows the specific processing routine of the characteristic term extraction processing to be executed by the characteristic term extraction unit 103 of this embodiment in step SP31 of the optimal case acquisition processing described above with reference to FIG. 13. When the characteristic term extraction unit 103 is called by the input document reception unit 13 in step SP30 of the optimal case acquisition processing, the characteristic term extraction unit 103 starts the characteristic term extraction processing shown in FIG. 20, and creates the first and second term lists 60, 61 by performing the processing of step SP50 to step SP52 in the same manner as the processing of step SP10 to step SP12 of the characteristic term extraction processing described above with reference to FIG. 8.

Subsequently, in cases where an error code is included in the target document 105, the characteristic term extraction unit 103 refers to the error code information 102 and extracts that error code from the target document 105, and creates the third term list 104 contained in the extracted error codes (SP53).

Next, the characteristic term extraction unit 103 ultimately acquires the characteristic terms 106 of the target document 105 by combining (merging) the terms that are respectively registered in the first to third term lists 60, 61, 104 which were created as described above (SP54).

The characteristic term extraction unit 103 thereafter ends the characteristic term extraction processing, and notifies the thus obtained characteristic terms of the inquiry text to the search execution unit 32.

According to the relevant information acquisition apparatus 100 of this embodiment having the foregoing configuration, for instance, in cases where an error code is included in the inquiry text, since that error code can also be extracted as a characteristic term, the user can investigate the cause and prepare a reply to an inquiry from a customer in a short period of time. According to the relevant information acquisition apparatus 100, the work efficiency of that user can be dramatically improved.

### (5) Other Embodiments

While the first to fourth embodiments described above explained a case of applying the present invention to the relevant information acquisition apparatuses 1, 70, 90, 100 having the configuration depicted in FIG. 1, FIG. 14 or FIG. 18, the present invention is not limited to the foregoing configuration, and the present invention may also be broadly applied to apparatuses having various configurations for acquiring optimal cases in relation to the inquiry text corresponding to the contents of a new inquiry from a customer among past cases accumulated with conversation history documents respectively including an inquiry from a customer and a reply to that inquiry.

Furthermore, while the first to fourth embodiments described above explained a case of retaining the conversation history documents of past cases in the relevant information acquisition apparatus 1, 70, 90, 100, the present invention is not limited to the foregoing configuration, and the conversation history documents of past cases may also be accumulated in an external storage device of the relevant information acquisition apparatus 1, 70, 90, 100.

Moreover, while the first to fourth embodiments described above explained a case of using two dictionaries; namely, the technical term dictionary and the search history dictionary, as the dictionaries to be used for extracting the characteristic terms from the cases and the inquiry text, the present invention is not limited to the foregoing configuration, and other dictionaries may also be applied in addition to the foregoing dictionaries, or only one of either the technical term dictionary or the search history dictionary (in the case of the second embodiment, only the search history dictionary) may be used to extract the characteristic terms.

In addition, while the first to fourth embodiments described above explained a case of storing, in the representative case column 19C of the cluster information 19 (FIG. 3), the case ID of the representative cases of the corresponding cluster, as well as the mutual relevance of the representative cases with other cases in the cluster as the score of those representative cases, the present invention is not limited to the foregoing configuration, and, for example, it is also possible to rank the respective representative cases in ascending order from the largest mutual relevance with the other cases in the corresponding cluster, and store such rank as the score of the representative cases in the representative case column 19C of the cluster information 19 (FIG. 3).

Furthermore, while the second embodiment described above explained a case of unconditionally adding a keyword, which was input as an additional keyword, to the search history dictionary (search history information 36), the present invention is not limited to the foregoing configuration, and, for example, it is also possible to present a list of keywords that were input as an additional keyword to the user at a predetermined timing, and have the user decide whether or not to add the keyword to the search history dictionary (search history information 36).

Moreover, while the fourth embodiment described above explained a case of configuring the dictionary information 101 from technical term information 35, search history information 36 and error code information 102, the present invention is not limited to the foregoing configuration, the error code information 102 may be omitted by registering all error codes in the technical term information 35.

In addition, while the fourth embodiment described above explained a case where, when an error code is included in the inquiry text, that error code is extracted as one of the characteristic terms from the inquiry text, the present invention is not limited to the foregoing configuration, it is also possible to retain in advance, as message code information, various messages other than the error code and the code assigned to the various messages including the error code, refer to the message code information when a message code is included in the inquiry text, extract that message code from the inquiry text, create a fourth term list containing the extracted message code, combining (merging) the terms respectively registered in the created fourth term list and the first and second term lists 60, 61, and thereby ultimately acquire the characteristic terms of the inquiry text.

Furthermore, while the second to fourth embodiments described above explained a case of applying the present invention to the first embodiment, the present invention is not limited to the foregoing configuration, the inventions of the second to fourth embodiments may also be combined to create a relevant information acquisition apparatus.

### INDUSTRIAL APPLICABILITY

The present invention can be broadly applied to apparatuses of various configurations which search for cases in which the inquiry content is similar to the inquiry text according to the contents of a new inquiry from a customer among the past cases accumulated with conversation history documents respectively including an inquiry from a customer and a reply to that inquiry.

### REFERENCE SIGNS LIST

1, 70, 90, 100: Relevant information acquisition apparatus
2: CPU
3: Memory
4: Storage device
7: Input device
8: Display device
11: Case management unit
12, 72, 91, 103: Characteristic term extraction unit
14: Case search unit
15: Search result display unit
17: Case storage unit
18: Inter-case relevant information
19: Cluster information
20, 101: Dictionary information
30: Inter-case relevance detection unit
31: Cluster creation unit
32: Search execution unit
33: Cluster identification unit
34: Representative case acquisition unit
35: Technical term information
36: Search history information
40: Inquiry text input screen
50, 80: Result output screen
60, 92: First term list
61: Second term list
72: Search history reflection unit
102: Error code information
104: Third term list

1. A relevant information acquisition method to be executed in a relevant information acquisition apparatus for acquiring, among past cases accumulated with conversation history documents respectively including an inquiry from a customer and a reply to that inquiry, the cases that may become a reference upon examining a cause of and measures taken against an event described in an inquiry text according to contents of a new inquiry from a customer, comprising:
a first step of extracting characteristic terms, which characterize each of the cases, from a corresponding conversation history document, and detecting a relevance among the cases based on the extracted characteristic terms of each of the cases and the conversation history documents of other cases;
a second step of classifying each of the cases into a plurality of clusters, which are an aggregate of the cases of high relevance, based on the detected relevance among the cases, assigning terms, as labels, which characterize the cluster to that cluster for each of the clusters, and determining representative cases consisting of cases that represents the cluster;
a third step of extracting, from the inquiry text, characteristic terms that characterize that inquiry text, and acquiring the cases that may become a reference upon examining the cause of and measures taken against the event described in the inquiry text based on the extracted characteristic terms of the inquiry text and the conversation history document of each of the cases;
a fourth step of identifying the one or more clusters to which each of the acquired cases belongs; and
a fifth step of classifying and displaying, for each of the clusters, the labels of each of the identified clusters and a part or all of the conversation history document of the representative cases.

2. The relevant information acquisition method according to claim 1,
wherein, in the first step:
a predetermined dictionary is used to extract the respective characteristic terms of each of the cases from the conversation history document of each of the cases, and
wherein, in the third step:
the dictionary used in the first step is used to extract, from the inquiry text, the characteristic terms of that inquiry text.

3. The relevant information acquisition method according to claim 2,
wherein the dictionary is configured from:
a technical term dictionary containing terms that appear as keywords in a manual of a target product or in materials of a field related to that product; and
a search history dictionary containing terms that were used as keywords during previous acquisition processing of cases that may become a reference upon examining the cause of and measures taken against the event described in the inquiry text, and
wherein, in the first and third steps:
a first term which is a term that is extracted based on a statistical technique from the conversation history document of the case or the inquiry text and a term that is registered in the search history dictionary is extracted, and a second term that is registered in the technical term dictionary is extracted from the conversation history document of the case or the inquiry text, and
the characteristic terms of the case or the inquiry text are extracted by combining the first and second terms.

4. The relevant information acquisition method according to claim 1,
wherein, in the second step:
the characteristic terms of each of the cases included in the cluster are totaled for each of the clusters, and few top terms among the characteristic terms that are common to more of the cases are assigned to the cluster as the labels of that cluster.

5. The relevant information acquisition method according to claim 1,
wherein, in the second step:
for each of the clusters, the cases having a high mutual relevance among the cases in the cluster are determined to be the representative cases of that cluster.

6. The relevant information acquisition method according to claim 1,
wherein, in the fourth step:
the identified clusters are ranked, and
wherein, in the fifth step:
the labels of each of the clusters and a part or all of the conversation history document of the representative cases are displayed in an order of ranking of the ranked clusters.

7. The relevant information acquisition method according to claim 6,
wherein, in the fourth step:
the ranking of the clusters is determined according to a number of the cases, which belong to that cluster, that may become a reference upon examining the cause of and measures taken against the event described in the inquiry text.

8. The relevant information acquisition method according to claim 2,
wherein, upon acquiring the cases that may become a reference upon examining the cause of and measures taken against the event described in the inquiry text by using a new keyword input by a user, that keyword is registered in the dictionary.

9. The relevant information acquisition method according to claim 3,
wherein, in the first and third steps:
scores are respectively assigned to the first and second terms, and the characteristic terms of the case or the inquiry text are extracted based on the scores of the first and second terms.

10. The relevant information acquisition method according to claim 9,
wherein, in the first and third steps:
the scores are assigned to the first and second terms based on a frequency of appearance of the first or the second term.

11. The relevant information acquisition method according to claim 3,
wherein the dictionary is configured from:
message code information describing a rule of a code assigned to a message in addition to the technical term dictionary and the search history dictionary, and
wherein, in the first and third steps:
the message code contained in the inquiry text is extracted based on the message code information in addition to the first and second terms, and
the characteristic terms of the case or the inquiry text are extracted by combining the first and second terms and the message code extracted from the inquiry text.

12. A relevant information acquisition apparatus for acquiring, among past cases accumulated with conversation history documents respectively including an inquiry from a customer and a reply to that inquiry, the cases that may become a reference upon examining a cause of and measures taken against an event described in an inquiry text according to contents of a new inquiry from a customer, comprising:
a characteristic term extraction unit for extracting characteristic terms, which characterize the cases or the inquiry text, from a corresponding conversation history document or the inquiry text;
an inter-case relevance detection unit for detecting a relevance among the cases based on the characteristic terms of each of the cases extracted by the characteristic term extraction unit and the conversation history documents of other cases;
a cluster creation unit for classifying each of the cases into a plurality of clusters, which are an aggregate of the cases of high relevance, based on the relevance among the cases detected by the inter-case relevance detection unit, assigning terms, as labels, which characterize the cluster to that cluster for each of the clusters, and determining representative cases consisting of cases that represents the cluster;
a case acquisition unit for acquiring the cases that may become a reference upon examining the cause of and measures taken against the event described in the inquiry text based on the characteristic terms of the inquiry text extracted by the characteristic term extraction unit and the conversation history document of each of the cases;
a cluster identification unit for identifying the one or more clusters to which each of the cases, which was acquired by the case acquisition unit, belongs; and
a result display unit for classifying and displaying, for each of the clusters, the labels of each of the identified clusters and a part or all of the conversation history document of the representative cases.

13. A storage medium storing a program for causing a relevant information acquisition apparatus for acquiring, among past cases accumulated with conversation history documents respectively including an inquiry from a customer and a reply to that inquiry, the cases that may become a reference upon examining a cause of and measures taken against an event described in an inquiry text according to contents of a new inquiry from a customer, to execute processing comprising:
a first step of extracting characteristic terms, which characterize each of the cases, from a corresponding conversation history document, and detecting a relevance among the cases based on the extracted characteristic terms of each of the cases and the conversation history documents of other cases;
a second step of classifying each of the cases into a plurality of clusters, which are an aggregate of the cases of high relevance, based on the detected relevance among the cases, assigning terms, as labels, which characterize the cluster to that cluster for each of the clusters, and determining representative cases consisting of cases that represents the cluster;
a third step of extracting, from the inquiry text, characteristic terms that characterize that inquiry text, and acquiring the cases that may become a reference upon examining the cause of and measures taken against the event described in the inquiry text based on the extracted characteristic terms of the inquiry text and the conversation history document of each of the cases;
a fourth step of identifying the one or more clusters to which each of the acquired cases belongs; and
a fifth step of classifying and displaying, for each of the clusters, the labels of each of the identified clusters and a part or all of the conversation history document of the representative cases.
